(19) United States
(12) Patent Application Publication
(10) Pub. No.: US 2006/0029213 A1
(43) Pub. Date: Feb. 9, 2006

(54) COMMUNICATION ARRANGEMENT AND TRANSMISSION UNIT FOR INFORMATION TRANSFER OVER A TRANSMISSION AND A CIRCUIT ARRANGEMENT FOR CONNECTION TO THE TRANSMISSION UNIT

(76) Inventor: Paul Kunisch, Puchheim (DE)

Correspondence Address: Siemens Corporation;Intellectual Property Department, 170 Wood Avenue South, Iselin, NJ, 08830, US

(21) Appl. No.: 10/525,156

(22) PCT Filed: Aug. 8, 2003
(86) PCT No.: PCT/DE03/02673

§ 371 Date: Feb. 18, 2005

(30) Foreign Application Priority Data
Aug. 30, 2002 (DE) 102 40 140.3

(51) Int. Cl. H04M 1/00

(52) U.S. Cl. 379/399.01

(57) ABSTRACT

A transmission unit, each with an active or passive operating state is connected to a transmission line with an input impedance which is dependent on the current operating state. According to the invention, a switchable electrical component is connected dependent on the determined operating state such that the input impedance of the transmission unit is kept to an almost constant value. Impedance jumps on activation or deactivation of the transmission unit are advantageously avoided, such that distortion or interruptions in the information transmission by means of the transmission line are avoided.

### CROSS REFERENCE TO RELATED APPLICATIONS

This application is the US National Stage of International Application No. PCT/DE03/02673, filed Aug. 8, 2003 and claims the benefit thereof. The International Application claims the benefits of German application No. 10240140.3 DE filed Aug. 30, 2002, both of the applications are incorporated by reference herein in their entirety.

### FIELD OF INVENTION

This invention relates to a communication arrangement and transmission unit for information transfer over a transmission line and a circuit arrangement for connection to the transmission unit.

### BACKGROUND OF INVENTION

In current subscriber access networks—also referred to as access networks for short—the subscribers are frequently connected by means of copper wire pairs or 2-wire lines to the locally closest switching equipment. Over said 2-wire line, both narrow-band signals, for example signals embodied in accordance with the ISDN transmission method, and wideband signals, for example signals embodied by means of an xDSL transmission method, are transferred between the switching equipment and the subscribers connected thereto.

FIG. 1 illustrates a connection scenario currently used in existing subscriber access networks, by means of which a subscriber is provided with both a narrowband subscriber access (ISDN transmission) and a wideband subscriber access (xDSL transmission). According to FIG. 1, the xDSL transmission is directly connected to the 2-wire line, in other words without the use of a splitter. With the ISDN transmission, the same frequency spectrum is used in both directions. A method of direction separation is required for the transmission of the signals transmitted in both transmission directions over a common transmission channel (in this case the copper wire pair). The echo compensation method is frequently used in this case. In the echo compensation method, the direction separation is performed in a first step by means of a hybrid circuit—also referred to below as a hybrid—one of which is disposed at either end of the transmission line. At the same time the transition between two-wire and four-wire line is also implemented by means of the hybrid circuit.

The echo compensation method has the disadvantage that on account of the incomplete line balance in the hybrid circuit and as a result of additional reflections on the transmission path, some of the send signals enter the home receiver as an echo and so overlay the incoming receive signal as an interference signal. Through the use of an echo compensator said echo is balanced adaptively, i.e. adjusts itself automatically to the line, and is subtracted from the signal of the receive direction (consisting of receive signal and echo), with the result that finally only the desired receive signal reaches the receiver. The echo compensator is configured as a transversal filter (low-pass) whose coefficients are adaptively set by a controller.

With longer subscriber access lines, the signal transmitted by a subscriber in the direction of the switching center or, as the case may be, switching equipment—referred to in the following as the upstream signal—is heavily attenuated at the point of reception (switching equipment) and heavily distorted due to the frequency-dependent group delay. The signal transmitted, in comparison therewith, at high power in the direction of the subscriber—referred to in the following as the downstream signal—overlays the upstream signal. The purpose of the hybrid circuit or, as the case may be, of the hybrid and the echo compensator is to subtract almost completely the downstream signal reflected at the hybrid circuit on the switching equipment side, which downstream signal overlays the user information signal received on the switching equipment side in the upstream direction. This means that even the smallest changes in the impedance of the 2-wire line lead to a change in the transhybrid loss (with regard to phase and amplitude) and the echo compensator together with the equalizer have to be reset.

For the connection scenario illustrated in FIG. 1, the transformer Tr1 is terminated with the impedance of the subscriber access line Z_{Ltg} for the transmission paths with regard to the ISDN and the xDSL transmission. In parallel therewith, the impedance Z_{xDSL} of the xDSL transmission or, as the case may be, the xDSL line driver side is present. The transmission link of the xDSL transmission exhibits only a small stop-band attenuation in the frequency range of the ISDN transmission (up to approx. 140 kHz), with the result that impedance changes on the xDSL line driver side also have an impact on the input impedance Z_{xDSL}. For this reason, even a slight change in the input impedance Z_{xDSL} leads to interferences and interruptions in the ISDN transmission. In current subscriber access networks, said impedance changes occur at the present time as a result of the activation or, as the case may be, deactivation of xDSL line drivers. These usually exhibit a high impedance in the idle condition; alternatively they can also have a low-impedance value.

A line driver implemented with the aid of a differential operational amplifier is described for example in U.S. Pat. No. 5,856,758. By means of said line driver a specific output impedance—also referred to as impedance synthesis—is synthesized by means of a voltage and current feedback in the active state. As a result of the impedance synthesis a reduction in the power dissipation is achieved and at the same time the supply voltage is minimized. However, when line drivers implementing an impedance synthesis are activated or, as the case may be, deactivated, abrupt changes in the output impedance—also referred to as impedance jumps—disadvantageously occur.

Line drivers without impedance synthesis are also known, for the operation of which, however, the open-circuit voltage has to be increased by up to 6 dB and the external resistors have to be increased significantly by a specific impedance synthesis factor. This leads to an increased power consumption and to additional power dissipation.

With current solutions for the design of xDSL line drivers, impedance jumps can be avoided to a large extent only under the conditions listed below:
If the line drivers assume a very low-impedance state in the idle condition (short-circuit to ground) and remain low-impedance in the active state, i.e. no impedance synthesis is implemented. With line drivers with impedance synthesis, on the other hand, the above-mentioned interferences occur during switchovers between operating modes.
If the xDSL transmission remains permanently active, though this is associated with a number of disadvantages—for example increased power dissipation, additional overhead for cooling (air conditioning system), energy costs, and increased interferences in the cable.

### SUMMARY OF INVENTION

The object of the invention is therefore to avoid interfering interruptions to the ISDN transmission on subscriber access lines caused by the activation or deactivation of the xDSL transmission, more particularly of the xDSL line drivers. The object is achieved on the basis of a communication arrangement, a transmission device, and a circuit arrangement according to the features patent claims.

In the communication arrangement for information transfer according to the invention, there is connected to at least one transmission line at least one transmission unit having an active or passive operating state in each case for the purpose of sending and/or receiving information having an input impedance dependent on the current operating state. The essential aspect of the communication arrangement according to the invention is that sensing means for detecting the current operating state of the transmission unit are provided, to which there are assigned impedance means by means of which at least one switchable electrical component is connected as a function of the detected operating state in such a way that the input impedance of the at least one transmission unit is kept to an approximately constant value.

The essential advantage of the communication arrangement according to the invention is that impedance jumps during the activation or, as the case may be, deactivation of the transmission unit connected to the transmission line are prevented. As a result of the avoidance of impedance jumps, the interference to or, as the case may be, interruption of an already running transmission of information over the same transmission line—for example, an ISDN transmission—is avoided. As a result of the avoidance of impedance jumps the transhybrid loss (with regard to phase and amplitude) is kept to an approximately constant value, with the result that with regard to the ISDN transmission the echo compensator and equalizer no longer have to be reset.

Further advantageous embodiments of the communication arrangement according to the invention and a transmission device for sending and/or receiving information and a circuit arrangement which can be connected to the transmission device can be derived from the dependent claims.

### BRIEF DESCRIPTION OF THE DRAWINGS

FIG. 1. Illustrates a connection scenario currently used in existing subscriber access networks.

FIG. 2. Illustrates an exemplary embodiment of the communication arrangement in accordance to the invention.

### DETAILED DESCRIPTION OF INVENTION

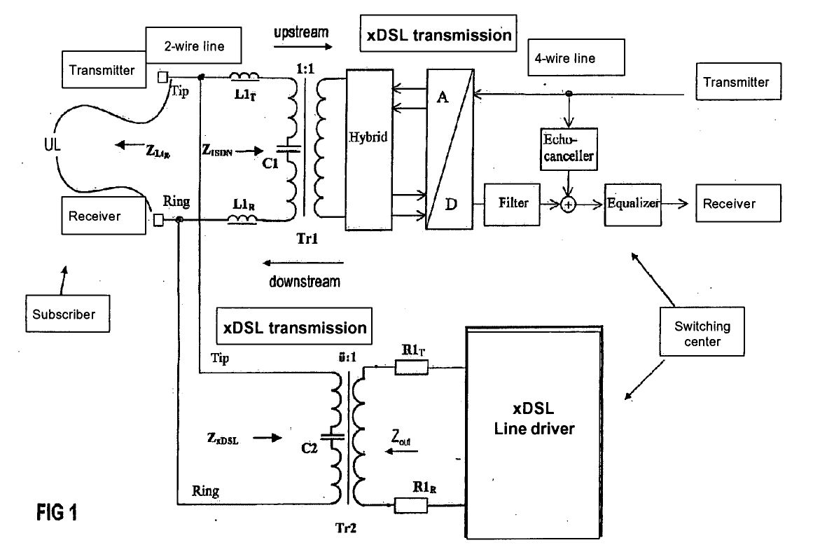

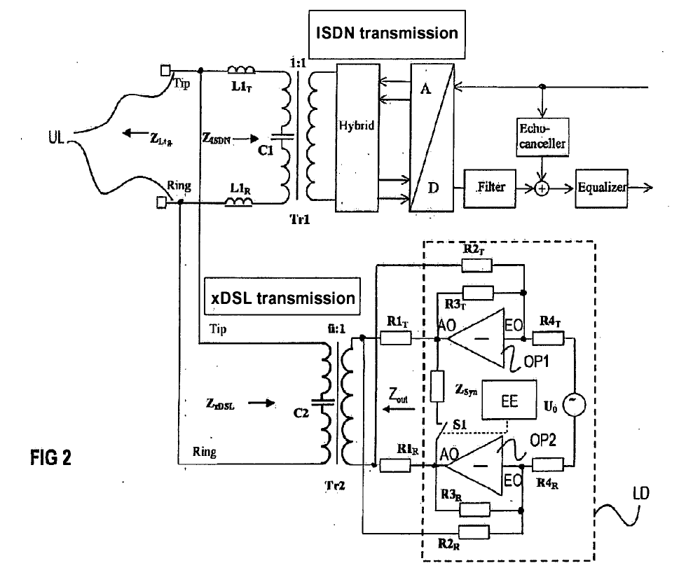

The communication arrangement according to the invention will be explained in more detail below with reference to a block diagram. FIG. 2 illustrates the connection scenario already explained in general terms in FIG. 1, which represents the end at the switching center side both of the narrowband transmission (ISDN transmission) and of the wideband transmission (xDSL transmission). In this exemplary embodiment the line driver represented generally in FIG. 1 is embodied as an xDSL line driver LD with impedance synthesis. The xDSL line driver LD comprises 2 operational amplifiers OP 1,2, each of which has an output AO. According to the invention the outputs AO of the two operational amplifiers OP 1,2 can be connected to each other via a switch S and an impedance Z_{Syn}.

According to the invention the switch S is connected to an evaluation logic by means of which the active or, as the case may be, passive state of the xDSL line driver LD can be determined. For example the evaluation logic can be embodied as the sensing unit EE assigned to the xDSL line driver LD for the purpose of evaluating wake-up signals transmitted over the transmission line UL in accordance with the ITU-T G.992.2 standard. On the basis of the wake-up signals brought to the xDSL line driver LD the current active or, as the case may be, passive state can be determined in each case by the sensing unit EE and the switch S opened or, as the case may be, closed depending on the detected state.

Furthermore each of the outputs AO of the two operational amplifiers OP1,2 is feedback-coupled to a corresponding input EO of the respective operational amplifier OP1,2 in each case via a resistor R3_{T}, R3_{R}. Also, the input EO of the first operational amplifier OP1 is connected via a resistor R2_{T} and a resistor R1_{R} to the output AO of the second operational amplifier OP2. Similarly, the input EO of the second operational amplifier OP2 is connected to the output AO of the first operational amplifier OP1 via a resistor R2_{R} and a resistor R1_{T}. Each of the outputs of the two operational amplifiers OP1,2 is connected via the resistor R1_{T}, R1_{R} to a transformer Tr2. The inputs EO of the two operational amplifiers OP1,2 are connected to each other via resistors R4_{T}, R4_{R} and via an alternating voltage source U₀ (which in this exemplary embodiment represents the xDSL data signal to be transmitted in the direction of the subscriber).

The xDSL line driver LD is connected to the subscriber access line UL via the transformer Tr2 having the transmission ratio ü: 1. It will be assumed in the following that the xDSL line driver LD is activated only when there is actually information present on the switching center VST side that is to be transmitted to the subscriber access line UL or when wake-up signals are detected by the sensing unit. The inductors L1_{T}, L1_{R} represented in FIG. 2 and assigned to the transmission line UL represent a low-pass filter by means of which frequency components of the xDSL transmission which lie above the frequency spectrum of the ISDN transmission are attenuated. The capacitors C1, C2 are used for direct current separation.

Let the following values be assumed for this exemplary embodiment:
C1≈1 μF, C2≈10 nF
L_{Tr1}≈10 mH, L_{Tr2}≈1 mH, L1≈200 μH

Let the following ratios be assumed for the circuitry of the xDSL line driver LD:
R1_{T}=R1_{R},R2_{T}=R2_{R}
R3_{T}=R3_{R}, R4_{T}=R4_{R}
R2,R3,R4>>R1

With regard to the xDSL line driver the following impedance synthesis factor k_{synth.} is produced:
k_{synth.}(=R2/R2−R3)

The output impedance Zₒᵤₜ of the xDSL line driver LD is yielded as:
Zₒᵤₜ=k_{synth.}*(2*R1)

According to the invention the following value is specified for the switchable resistor Z_{Syn}:
Z_{Syn}=Zₒᵤₜ−2*R1

In the calculation of the resistor Z_{Syn} the resistors R2, R3 and R4 can usually be ignored, because they lie approximately 2 orders of magnitude over the value of R1.

According to the invention the sensing unit EE and the switch S connected thereto are configured as follows:
With an actively or, as the case may be, low-impedance connected xDSL line driver LD, the switch S1 is open and therefore the transformer Tr2 is terminated by Zₒᵤₜ on the driver side.
With deactivated (passive) or, as the case may be, high-impedance connected xDSL line driver LD (idle condition) the switch S1 is closed, as a result of which the resistor Z_{Syn}=Zₒᵤₜ−2*R1 is switched between the outputs AO of the two operational amplifiers OP1,2. [symbol] Thus, the transformer Tr2 is terminated on the driver side by
   Zₒᵤₜ=2*R1+Z_{Syn.}

Taking into account the specification according to the invention for the impedance
Z_{Syn}=Zₒᵤₜ−2*R1
the following applies:
Zₒᵤₜ=2*R1+Z_{syn}=2*R1+Zₒᵤₜ−2*R1=Zₒᵤₜ

It follows from the last relation that the xDSL line driver LD is terminated by the same output impedance Zₒᵤₜ both in the active and in the passive state. Through the switching of a resistor with the value Z_{Syn}=Zₒᵤₜ−2*R1 between the two outputs AO of the operational amplifiers OP1,2 of the line driver LD in the idle condition, an impedance jump is avoided on the side of the xDSL line driver during the activation or, as the case may be, deactivation of the xDSL transmission, which activation or deactivation would otherwise lead to an interruption of the ISDN transmission because of the need to reset the echo compensator.

Alternatively, the switchable impedance Z_{Syn} according to the invention can be embodied—optionally together with the switch S—as external supplementary circuitry (not shown) assigned to the xDSL line driver. According to a further embodiment variant (not shown) the supplementary circuitry may also comprise the sensing unit EE.

1.-14. (canceled)

15. A communication arrangement for an information transfer over a transmission line operatively connected to a first transmission unit, the first transmission unit for communicating information with an input impedance dependent on a current operating state, comprising:
a sensor for detecting the current operating state of the first transmission unit;
an impedance assigned to the sensor; and
a switchable electrical component provided as a function of the detected current operating state such that the input impedance of the first transmission unit is kept to an approximately constant value,
wherein the current operating state comprises an active operating state or a passive operating state.

16. The communication arrangement as claimed in claim 15, wherein the communication information is sent from the first transmission unit or received by the first transmission unit.

17. The communication arrangement as claimed in claim 15, wherein the communication information is sent from the first transmission unit and received by the first transmission unit.

18. The communication arrangement as claimed in claim 15, wherein the first transmission unit comprises a plurality of operational amplifiers for transmitting the information onto the transmission line, the switchable electrical component comprising a switch for switching between outputs of the plurality of operational amplifiers, the impedance and the sensor being adapted so that the switch is open in the active operating state and closed in the passive operating state.

19. The communication arrangement as claimed in claim 15, wherein the switchable electrical component comprises an electrical resistor.

20. The communication arrangement as claimed in claim 15, wherein the switchable electrical component is operatively connected to an electrical resistor.

21. The communication arrangement as claimed in claim 15, further comprising a transmission that is embodied in accordance with an xDSL transmission method.

22. The communication arrangement as claimed in claim 15, further comprising a second transmission unit for sending or receiving information, the second transmission unit embodied in accordance with an ISDN transmission method and is operatively connected to the transmission line.

23. The communication arrangement as claimed in claim 15, further comprising a second transmission unit for sending and receiving information, the second transmission unit embodied in accordance with an ISDN transmission method and is operatively connected to the transmission line.

24. The communication arrangement as claimed in claim 15, wherein the sensor is adapted so that an activation signal transmitted over the transmission line is detected, and that when the activation signal is detected the active operating state of the first transmission unit is established.

25. The communication arrangement as claimed in claim 24, wherein the activation signal is a wake-up signal in accordance with an ITU-T G.922 standard.

26. A transmission unit for communicating information over a transmission line, comprising:
a current operating state having an active or a passive operating state;
an input impedance dependent on the current operating state;
a sensor for detecting the current operating state of the transmission unit; and
an impedance assigned to the sensor via a switchable electrical component, the switchable electrical component provided as a function of the detected current operating state so that the input impedance of the transmission unit is kept to an approximately constant value.

27. The transmission unit as claimed in claim 26, further comprising a plurality of operational amplifiers for transmitting information onto the transmission line.

28. The transmission unit as claimed in claim 27, wherein the switchable electrical component is switched between outputs of the amplifiers via a switch controlled by the sensor, the impedance and the sensor adapted so that the switch is open in the active operating state and closed in the passive operating state.

29. The transmission unit as claimed in claim 26, wherein the switchable electrical component comprises an electrical resistor.

30. The transmission unit as claimed in claim 26, wherein the transmission unit is embodied in accordance with an xDSL transmission method.

31. The transmission unit as claimed in claim 26, wherein an external circuit arrangement which can be operatively connected to the transmission unit comprises the sensor and the impedance.

32. A circuit arrangement for external connection to a transmission unit, the transmission unit for communicating information over a transmission line, comprising:
a current operating state of the transmission unit, the current operating state having an active or a passive operating state; and
an impedance assigned to a sensor via a switchable electrical component, the switchable electrical component having a switch and provided as a function of the detected current operating state so that an input impedance of the transmission unit is kept to an approximately constant value.

33. The circuit arrangement as claimed in claim 32, further comprising the sensor.
